(19) United States
(12) Patent Application Publication
(10) Pub. No.: US 2014/0355934 A1
(43) Pub. Date: Dec. 4, 2014

(54) OPTICS SYSTEM FOR USE IN A PARALLEL OPTICAL COMMUNICATIONS MODULE

(71) Applicant: Avago Technologies General IP (Singapore) Pte. Ltd., Singapore (SG)

(72) Inventors: Bing Shao, Sunnyvale, CA (US); Ye Chen, San Jose, CA (US); Chi Keung Lee, Palo Alto, CA (US); Andrew J. Schmit, Sunnyvale, CA (US)

(21) Appl. No.: 13/904,914

(22) Filed: May 29, 2013

(51) Int. Cl. G02B 6/32

(52) U.S. Cl. CPC G02B 6/32
USPC 385/33

(57) ABSTRACT

An optics system for use with a parallel optical communications module is provided that includes a support structure for supporting the ends of the optical fibers in a way that ensures that the ends of the optical fibers are maintained in precise optical alignment with respective optical coupling elements of the optics system. The support structure makes it virtually impossible for there to be any misalignment between the ends of the optical fibers and the respective optical coupling elements of the optics system to prevent misalignment problems from occurring. In addition, the optics system is configured in such a way that the likelihood that the ends of the optical fibers will be damaged as they are inserted into the optics system is very small.

### TECHNICAL FIELD OF THE INVENTION

The invention relates to optical communications modules. More particularly, the invention relates to an optics system and method for use in a parallel optical communications module.

### BACKGROUND OF THE INVENTION

A parallel optical communications module is a module having multiple transmit (Tx) channels, multiple receive (Rx) channels, or both. A parallel optical transceiver module is an optical communications module that has multiple Tx channels and multiple Rx channels in the Tx and Rx portions, respectively, of the transceiver module. The Tx portion comprises components for transmitting data in the form of modulated optical signals over multiple optical waveguides, which are typically optical fibers. The Tx portion includes a laser driver integrated circuit (IC), a plurality of laser diodes and a controller IC, which are mounted on a module printed circuit board (PCB). The laser driver circuit outputs electrical signals to the laser diodes to modulate them. When the laser diodes are modulated, they output optical signals that have power levels corresponding to logic 1 s and logic 0 s. An optics system of the module focuses the optical signals produced by the laser diodes into the ends of respective transmit optical fibers of an optical fiber cable, such as an optical fiber ribbon cable. The optics system is typically mechanically coupled with a connector module that mates with the transceiver module. The ends of the optical fibers are typically mechanically coupled to the optics system and are held in precise optical alignment with optical elements (e.g., lenses) of the optics system.

The Rx portion includes a plurality of receive photodiodes mounted on the PCB that receive incoming optical signals output from the ends of respective receive optical fibers held in the connector. The optics system of the transceiver module focuses the light that is output from the ends of the receive optical fibers onto the respective receive photodiodes. The receive photodiodes convert the incoming optical signals into electrical analog signals. An electrical detection circuit, such as a transimpedance amplifier (TIA), receives the electrical signals produced by the receive photodiodes and outputs corresponding amplified electrical signals, which are processed in the Rx portion to recover the data.

There is a demand in the optical communications industry for optical communications systems that are capable of simultaneously transmitting and receiving ever-increasing amounts of data. To accomplish this, it is known to edge mount or mid-plane mount multiple parallel optical transceiver modules in a mounting plane. In edge mounting configurations, the mounting plane is a front panel of a system box, and the modules are inserted into openings formed in the front panel. In mid-plane mounting configurations, the mounting plane is a motherboard PCB, and the modules are mounted on receptacles disposed on the motherboard PCB.

One of the problems associated with the existing or proposed mid-plane mounting solutions is that there are limitations on the mounting density of the modules on the motherboard PCB. One of the reasons for this is that the optical fiber ribbon cables that connect to the modules typically pass out of a side of the module parallel to the upper surface of the motherboard PCB, which makes it necessary to provide some space between adjacent modules to avoid having to bend the ribbon cable beyond its minimum bend radius to allow it to pass over the top of the adjacent module. Consequently, the number of modules that can be mounted on the motherboard is limited by the additional space needed between adjacent modules to accommodate the cables.

One known solution to this problem is to incline the module or to incline the optics system that couples the cable to the module such that the cable extends from the module at a non-zero angle relative to the upper surface of the motherboard PCB. For example, a company called US Conec of Hickory, N.C. provides an inclined optics system that mates with a parallel optical communications module and attaches to the end of an optical fiber cable. Because of the inclined optics system, the cable extends from the module at a non-zero angle relative to the upper surface of the motherboard PCB. However, because of the manner in which the fibers are coupled to the optics system, optical losses may occur that lead to performance problems.

The optics system has bores formed in it for receiving end portions of respective optical fibers. The bores are in precise alignment with respective optical elements of the optics system. The end portions of the fibers are passed through the respective bores such that the ends of the optical fibers are positioned in close proximity to the respective optical elements of the optics system. The end portions are then fixedly secured to the optics system with a refractive index-matching epoxy.

Because of the very small sizes of the fibers and the bores, inserting the fiber end portions into the bores can be a difficult task and can result in the ends of the fibers being damaged if they make contact with a hard surface of the optics system as attempts are being made to insert them into the respective bores. Of course, any damage to the fibers can result in performance problems. Another problem with this type of alignment configuration is that even when the fiber end portions are disposed within the respective bores and secured in place with epoxy, the fiber ends that extend outside of the bores adjacent to the respective optical coupling elements may not be precisely aligned with the respective optical coupling elements. The ends of the fibers are not supported by any type of structure of the optics system, but are merely disposed in a reservoir that is filled with a refractive index matching epoxy. For this reason, it is possible that the fiber ends will not be precisely aligned with the respective optical elements, which can result in optical coupling losses and performance problems.

A need exists for an optics system for use in a parallel optical communications module that ensures precise optical alignment between the fiber ends and the optical elements of the optics system. A need also exists for an optics system that obviates the need to provide space between adjacent parallel optical communications modules to accommodate the optical fiber cables.

### SUMMARY OF THE INVENTION

The invention is directed to an optics system and a method for use with an optical communications module for coupling light between ends of optical fibers secured to the optics system and respective optoelectronic elements of the optical communications module. The optics system comprises a body, a plurality of optical coupling elements, and a cover. The body has a top surface, a bottom surface, a front end, a back end, a left side, and a right side. The top surface has a chamber formed therein having a back, a middle and a front. The front of the chamber is defined by a stop that is transparent to an operating wavelength of light.

The back end of the body has an opening therein that is defined by a guide surface, a crossbeam, the left side of the body, and the right side of the body. The opening extends from the back end of the body into the chamber and is adapted to allow end portions of a plurality of optical fibers to be inserted through the opening and received in the chamber. The chamber has a bottom surface having a first surface portion and a second surface portion. The first surface portion extends from the back of the chamber to approximately the middle of the chamber. The second surface portion extends from the first surface portion to the front of the chamber. The second surface portion has a plurality of grooves formed therein for holding respective end portions of a plurality of optical fibers.

Each of the optical coupling elements is aligned with a respective one of the grooves such that when the end portions of the optical fibers are held in the grooves, ends of the respective optical fibers are in alignment with the respective optical coupling elements. The cover is adapted to be secured to the body such that at least a bottom portion of the cover is disposed inside of the chamber in abutment with the end portions of the optical fibers when the optical fibers are held in the respective grooves.

The method comprises:
mounting the optics system described above on an optical communications module, wherein the end portions of the optical fibers pass through the opening and are disposed in the respective grooves, and wherein the cover is secured to the body such that at least a bottom portion of the cover is disposed inside of the chamber in abutment with the end portions of the optical fibers; and
using the optical coupling elements to couple light between the ends of the optical fibers and respective optoelectronic elements of the optical communications module.

These and other features and advantages of the invention will become apparent from the following description, drawings and claims.

### BRIEF DESCRIPTION OF THE DRAWINGS

FIGS. 1A and 1B illustrate top perspective views of the optics system in accordance with an illustrative embodiment.

FIG. 1C illustrates a bottom perspective view of the optics system shown in FIGS. 1A and 1B.

FIG. 1D illustrates a top perspective view of the optics system shown in FIGS. 1A and 1B with a cover positioned above the optics system and with ends of two optical fibers disposed in grooves formed in a chamber of the optics system.

FIG. 1E illustrates a top perspective view of the optics system shown in FIG. 1D with the cover secured thereto.

FIG. 1F illustrates a plan view of the optics system shown in FIG. 1E.

FIG. 1G illustrates a cross-sectional side view of the optics system shown in FIG. 1E taken along line A-A′.

### DETAILED DESCRIPTION OF AN ILLUSTRATIVE EMBODIMENT

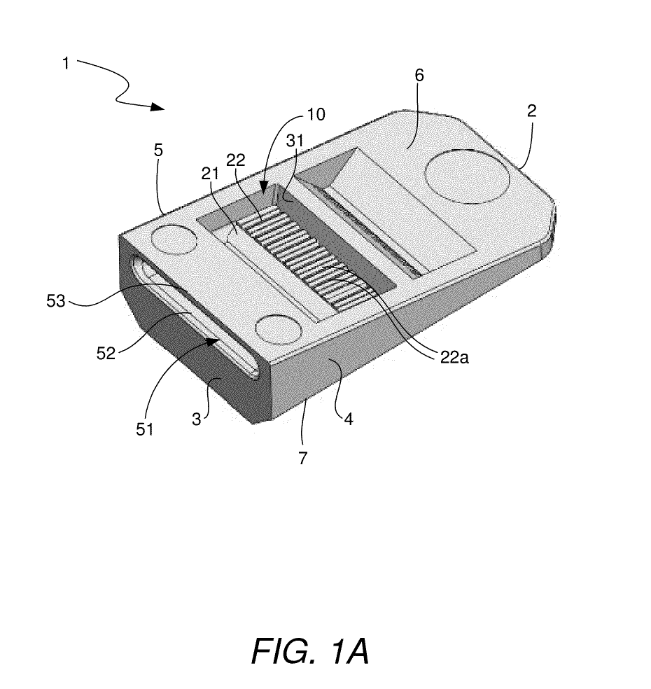

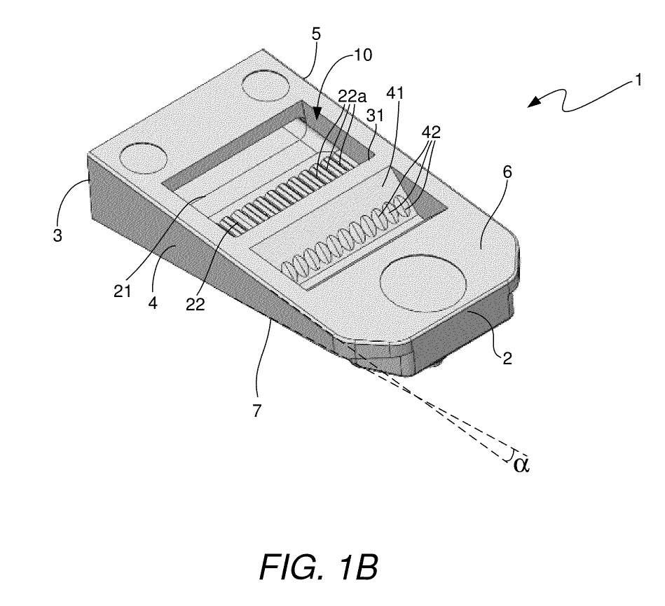

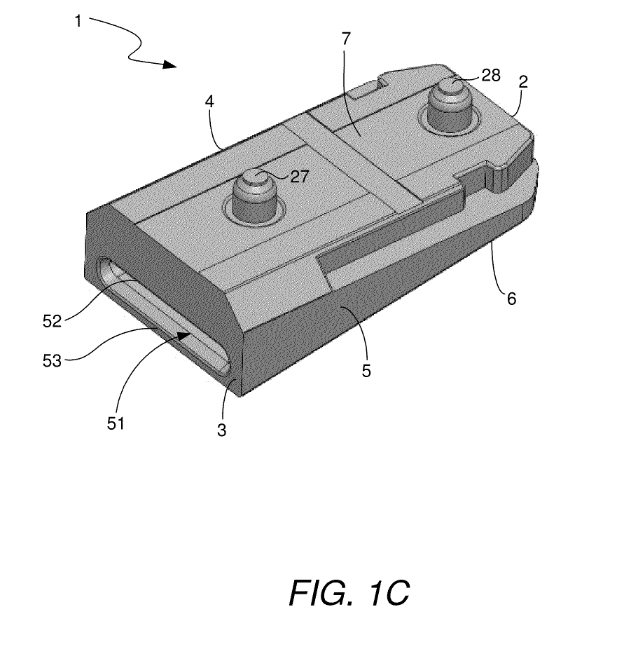

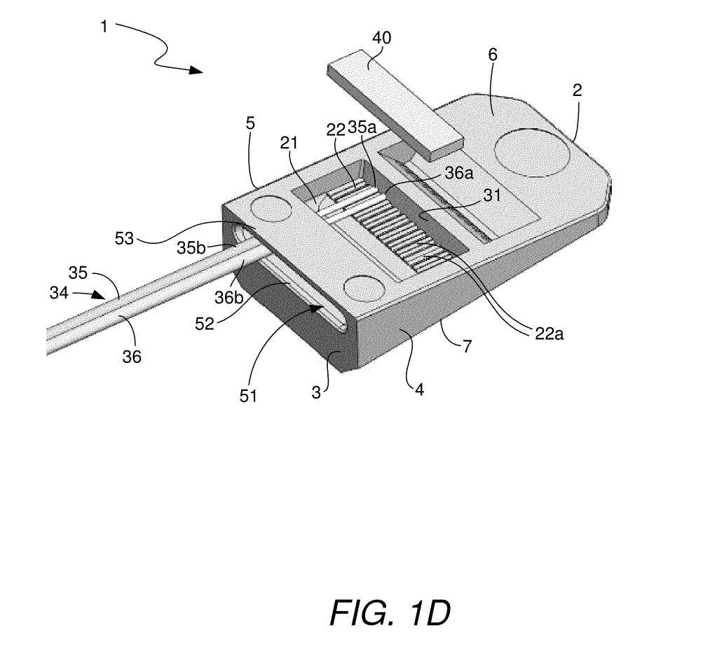

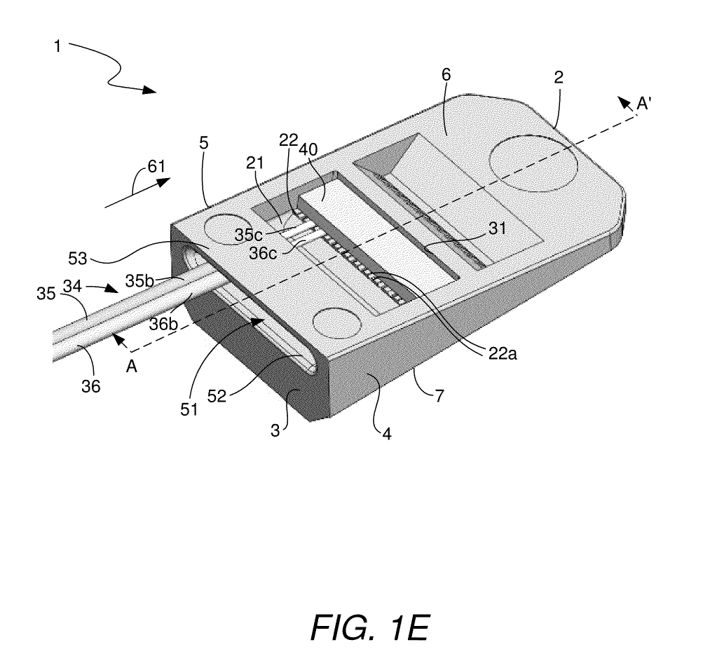

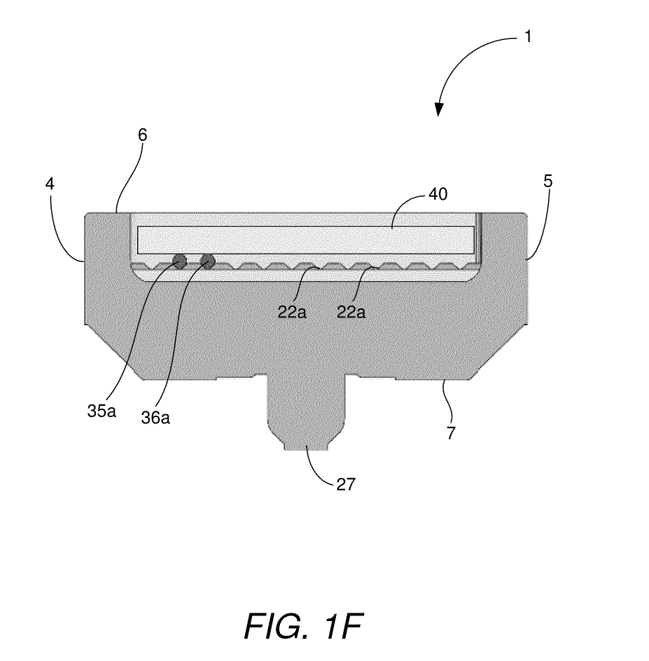

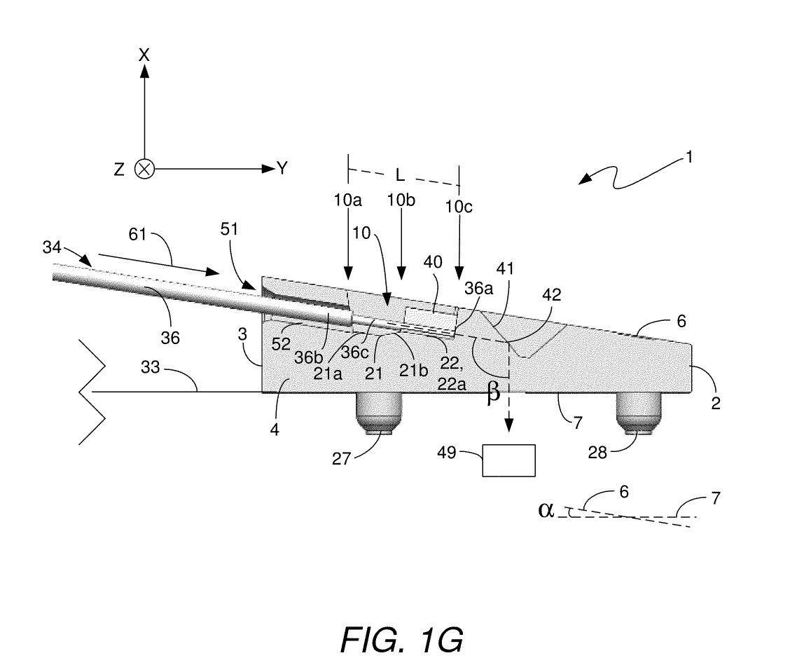

In accordance with the invention, an optics system for use with a parallel optical communications module is provided that includes a support structure for supporting the ends of the optical fibers in a way that ensures that the ends of the optical fibers are maintained in precise optical alignment with respective optical coupling elements of the optics system. The support structure makes it virtually impossible for there to be any misalignment between the ends of the optical fibers and the respective optical coupling elements of the optics system. This prevents the misalignment problems that were possible with the known aforementioned inclined optics system. In addition, the optics system is configured in such a way that the likelihood that the ends of the optical fibers will be damaged as they are inserted into the optics system is very small. An illustrative, or exemplary, embodiment of the optics system will now be described with reference to FIGS. 1A-1G, in which like reference numerals represent like elements, features or components.

With reference to FIGS. 1A and 1B, the optics system 1, in accordance with this illustrative embodiment, is a molded plastic part, or body, having a front end 2, a back end 3, a right side surface 4, a left side surface 5, a top surface 6, and a bottom surface 7. In accordance with this illustrative embodiment, the top surface 6 is at an angle of inclination, α, relative to the bottom surface 7, as shown in FIGS. 1B and 1G. The angle of inclination, α, ranges from about 5° to about 30° and is typically in the range of from about 9° to about 15°. The angle of inclination will depend on a variety of factors, such as, for example, the type of optical fiber cable that is used with the optics system 1, the intended spacing between adjacent parallel optical communications modules on the motherboard, the height of the parallel optical communications modules, the minimum allowable bend radius of the optical fiber cable, and the optical coupling elements that are used in the optics system 1 for coupling light between the fiber ends and the optoelectronic elements of the module.

As can be seen in FIG. 1G, because of the inclination of the top surface 6 relative to the bottom surface 7, the cable 34 extends from the module 33 at a non-zero angle relative to the upper surface of the module 33 on which the optics system 1 is mounted. For purposes of clarity, only the upper surface of the module 33 is shown in FIG. 1G. For illustrative purposes, it will be assumed that the upper surface of the module 33 is parallel to the upper surface of the motherboard PCB on which it is mounted, and that the upper surfaces of the module 33 and of the motherboard PCB are both parallel to the Y-Z plane of the X, Y, Z Cartesian coordinate system shown in FIG. 1G. For example, assuming that the angle of inclination a is equal to 9°, the cable 34 extends from the optics system 1 at an angle of 9° relative to the upper surface of the module 33.

This inclination feature allows a second, like module (not shown) to be mounted on the same motherboard PCB behind the module 33 and in close proximity to it without having to bend the cable 34 to allow it to clear the optics system mounted on the second module (not shown). As indicated above with reference to the known inclined optics system, this feature allows the modules to be mounted with relatively high mounting density on the motherboard PCB without risking damaging the cables. However, with the known inclined optics system described above, the ends of the optical fibers are left unsupported inside of the optics system and can therefore be misaligned from their respective optical coupling elements. In addition, with the known inclined optics system described above, the process of inserting the ends of the optical fibers into the respective bores can result in the ends coming into abutment with the optics system, which can damage the ends of the fibers or cause the fibers to break. As will be described below in more detail, the configuration of the optics system 1 prevents, or at least lessens the possibility, that misalignment or damage to the ends of the optical fibers will occur.

The optics system 1 has a chamber 10 formed therein having a bottom surface that comprises a first surface portion 21 (FIGS. 1A and 1B) and a second surface portion 22 (FIGS. 1A and 1B). As can be better seen in the side cross-sectional view of FIG. 1G, the first surface portion 21 is a non-planar surface that transitions from a downwardly-sloped portion 21a near the back 10a (FIG. 1G) of the chamber 10 to an upwardly-sloped portion 21b near the middle 10b (FIG. 1G) of the chamber 10. The first surface portion 21 is a non-planar surface in that the downwardly-sloped portion 21a and the upwardly-sloped portion 21b are in different planes. The downwardly-sloped portion 21a is generally parallel to the top surface 6 of the optics system 1, which, as can be seen in FIG. 1G, has a negative slope relative to X and Y axes of the X, Y, Z Cartesian Coordinate system. The terms “downwardly-sloped” and “upwardly-sloped” mean negatively-sloped and positively-sloped, respectively, relative to the X-Y plane of the Cartesian Coordinate system.

FIG. 1D shows two optical fibers 35 and 36 having ends 35a and 36a that are held within respective grooves 22a formed in the second surface portion 22 of the bottom surface of the chamber 10. In accordance with this illustrative embodiment, the grooves are V-shaped (hereinafter referred to as “V-grooves”). The ends 35a and 36a of the fibers 35 and 36, respectively, abut the stop 31 and are covered in a refractive index matching epoxy (not shown). Typically, after the fiber ends have been disposed within the V-grooves, the chamber 10 is filled with the refractive index matching epoxy. As shown in FIGS. 1D-1G, a cover 40 is then installed in the chamber 10 over the fiber ends. The cover 40 in combination with the refractive index matching epoxy prevents the fiber ends 35a and 36a from moving and maintains them in their aligned positions in the respective V-grooves 22a. As can be seen in FIG. 1F, the V-grooves 22a precisely locate the fiber ends 35a and 36a.

As can be seen in FIG. 1B, an angled surface 41 of the optics system 1 has a plurality of optical coupling elements 42 formed therein for folding the optical pathway of the optics system 1 to couple light between the fiber ends 35a and 36a and respective optoelectronic elements (not shown) of the parallel optical communications module 33 (FIG. 1G) with which the optics system 1 is used. The optical coupling elements 42 are not limited to being any particular types of optical coupling elements. In accordance with this illustrative embodiment, the optical coupling elements 42 are irregular, total-internal-reflection (TIR) lenses. Depending on whether the parallel optical communications module is a receiver, a transmitter or a transceiver, the TIR lenses 42 will either direct light passing out of a fiber end onto an optical-to-electrical (OE) conversion element (e.g., a photodiode) of the module 33 or will direct light emitted by an electrical-to-optical (EO) conversion element (e.g., a laser diode) of the module 33 into a fiber end.

Each of the TIR lenses 42 folds the respective optical pathway by a particular non-zero bend angle, β, that is selected based on the angle of inclination, α, of the top surface 6 relative to the bottom surface 7. This can be seen in FIG. 1G. The non-zero bend angle, β, is equal to α+90°. For example, in the case where α is equal to 9°, the bend angle β is equal to 99°. The prescription of the lenses 42 is selected based on a variety of considerations including, for example, the optical operations that they are intended to perform (e.g., focusing, collimation, etc.) and the angle by which they are intended to fold the optical pathways.

Because the optics system 1 is typically fabricated by a molding process as a single molded plastic part, the V-grooves 22a are capable of being very precisely positioned, shaped and sized such that when an optical fiber of a particular diameter is placed in the respective V-groove 22a, the core of the fiber is precisely located along a respective optical axis of a respective optical coupling element 42 of the optics system 1.

With reference again to FIG. 1G, the V-grooves 22a extend from the middle 10b of the chamber 10 to the front 10c of the chamber 10. The front 10c of the chamber 10 is defined by a stop 31. In accordance with this illustrative embodiment, the length, L, of the chamber 10 is about 1.6 millimeters (mm) and the length of the V-grooves 22a is about half of L, or 0.8 mm, although the chamber 10 and the V-grooves 22a are not limited to having any particular lengths. In accordance with this illustrative embodiment, the end portions of the fibers 35 and 36 that are supported in the respective V-grooves 22a are about 0.8 mm in length. The ends 35a and 36a of the fibers 35 and 36 are in abutment, or are nearly in abutment with, the stop 31. This structural support of the end portions of the fibers 35 and 36 that is provided by the V-grooves 22a over these lengths helps ensure that the ends 35a and 36a remain in their precisely-aligned positions. The stop 31 is transparent to the operating wavelength of light used by the parallel optical communications module 33.

As can be seen in FIGS. 1C and 1G, the bottom surface 7 of the optics system 1 has pins 27 and 28 formed thereon that are received in respective openings (not shown) formed in the upper surface of the parallel optical communications module 33 (FIG. 1G) with which the optics system 1 is designed to mate. When the optics system 1 is in its mated position shown in FIG. 1G, the optics system 1 is in precise alignment with the optical communications module 33 such that the optical pathways defined by the grooves 22a and by the optical coupling elements 42 are precisely aligned with the optical axes of the module 33. The optical axes of the module 33 corresponds to the optical axes of the light-emitting regions of light-emitting EO elements 49 (e.g., laser diodes and light-emitting diodes (LEDs)) and the optical axes of the light-receiving regions of light-receiving OE elements (e.g., photodiodes).

With reference to FIG. 1D, it can be seen that the back end 3 of the optics system 1 has an opening 51 formed in it that is defined by a guide surface 52 and by a crossbeam 53. The crossbeam 53 also provides the optics system 1 with a desired amount of torsional rigidity. As can be seen in FIG. 1G, the opening 51 extends from the back end 3 of the optics system 1 to the back 10a of the chamber 10. As can also be seen in FIG. 1G, the guide surface 52 extends from the back end 3 of the optics system 1 to the downwardly-sloped portion 21a of the first surface portion 21 of the bottom surface of the chamber 10. The guide surface 52 is a generally flat downwardly-sloped surface that typically has the same slope as that of the downwardly-sloped portion 21a.

The assembly process for securing the optical fibers 35 and 36 to the optics system 1 in accordance with this illustrative embodiment will now be described with reference to FIGS. 1D and 1G. The ends 35a and 36a of the optical fibers 35 and 36, respectively, are inserted through the opening 51 in the direction indicated by arrow 61. In accordance with this illustrative embodiment, the optical fibers 35 and 36 include outer jackets 35b and 36b, respectively, a portion of which has been removed to expose unjacketed fiber portions 35c and 36c, respectively. As the optical fibers 35 and 36 are inserted through the opening 51, the jacketed fiber portions 35b and 36b are generally supported by the guide surface 52. Lengths of the unjacketed fiber portions 35c and 36c are supported by the respective grooves 22a. The ends 35a and 36a abut the stop 31. Typically, the ends 35a and 36a are covered with a refractive index matching epoxy. Therefore, there may be very small separation spaces between the fiber ends 35a and 36a and the stop 31 that are filled with the refractive index matching epoxy.

It can be seen in FIG. 1G that the downwardly-sloped portion 21a of the first bottom surface portion 21 of the chamber 10 is a small vertical distance (in the X-direction) below the unjacketed fiber portions 35c and 36c (only 36c is visible in FIG. 1G). This feature of the chamber 10 is significant because it provides room for the fiber ends 35a and 36a to move in this area of the chamber 10 without abutting a hard surface as the installer is placing the fiber ends 35a and 36a in the respective V-grooves 22a. As indicated above with reference to the known tilted optics system, it is possible during the process of inserting the fiber ends into the bores that the fiber ends will come into contact with one or more hard surfaces of the optics system, resulting in the ends being damaged or breaking. The fiber ends are typically structurally weak and therefore easily damaged.

Because the optics system 1 does not use bores, but instead uses an opening 51 in combination with the grooves 22a to receive and hold the fiber ends 35a and 36a, the potential for the fiber ends 35a and 36a to be damaged during insertion is very remote. The extra space in the chamber 10 provided by the downwardly-sloped portion 21a (FIG. 1G) greatly reduces the likelihood that that the fiber ends 35a and 36a will abut any surfaces of the optics system 1 as they are being inserted into the optics system 1 and placed in the V-grooves 22a. The crossbeam 53 limits the angle of insertion of the fibers 35 and 36 to help align the ends 35a and 36a with the respective V-grooves 22a. Also, the upwardly-sloped portion 21b (FIG. 1G) of the first bottom surface portion 21 is a gradually sloping surface that ends where the grooves 22a begin. Consequently, even if the ends 35a and 36a do come into contact with the first bottom surface portion 21, the upwardly-sloped portion 21b will cause the ends 35a and 36a to slide smoothly along surface 21b until they find their respective grooves 22a. This sloping feature of the bottom surface of the chamber 10 further reduces the likelihood that the fiber ends 35a and 36a will be damaged or break as they are being positioned in the respective grooves 22a.

Because the optics system 1 can be manufactured with great precision, positioning the fiber ends 35a and 36a within the respective grooves 22a precisely aligns the fiber ends 35a and 36a with the respective optical coupling elements 42. After the fiber ends 35a and 36a have been placed in position in the respective grooves 22a, the chamber 10 is filled with the refractive index matching epoxy and the cover 40 is positioned within the chamber 10, as shown in FIGS. 1E-1G. The curing of the epoxy fixedly secures the cover 40 in place in the chamber 10, although there may be mechanical interlocking features (not shown) on the cover 40 and on the optics system 1 for locking the cover into position. Securing the cover 40 in place as shown in FIGS. 1E-1G prevents the fiber ends 35a and 36a from moving out of their aligned positions within the respective grooves 22a. Thus, unlike the known inclined optics system described above, it is virtually impossible for the fiber ends 35a and 36a to become misaligned.

It should be noted that the optical fiber cable 34 (FIGS. 1D, 1E and 1G) is not limited to being any particular type of optical fiber cable and that the optical fibers 35 and 36 may be, but need not be, contained within a common cable jacket. The term “cable,” as that term is used herein, is intended to denote two or more optical fibers that are grouped together, regardless of whether or not the fibers are attached to one another or contained within a common jacket. The ends 35a and 36a of the fibers 35 and 36, respectively, are typically cleaved and left unpolished. The refractive index matching epoxy prevents Fresnel reflection at the interface between the ends 35a and 36a and the stop 31.

It should be noted that many modifications can be made to the configuration of the optics system 1 shown in FIGS. 1A-1G without deviating from the scope of the invention. For example, the angle of inclination a could be zero such that the top and bottom surfaces 6 and 7, respectively, of the optics system 1 are parallel to one another and to the Y-Z plane (FIG. 1G). An optics system having such a configuration would still benefit from the features of the opening 51, the guide surface 52, the chamber 10, and the grooves 22 to ensure precise optical alignment while also preventing or at least lessening the possibility that the ends of the fibers will be damaged during the installation process.

It should be noted that the invention has been described with respect to illustrative embodiments for the purpose of describing the principles and concepts of the invention. The invention is not limited to these embodiments. For example, although the optics system 1 has been described as being a molded plastic part, it is not limited to being manufactured by any particular process or to being made of any particular material. As will be understood by those skilled in the art in view of the description being provided herein, modifications may be made to the embodiments described to provide a system that achieves the goal of the invention, and all such modifications are within the scope of the invention.

What is claimed is:

1. An optics system for use with an optical communications module for coupling light between ends of optical fibers secured to the optics system and respective optoelectronic elements of the optical communications module, the optics system comprising:
a body having a top surface, a bottom surface, a front end, a back end, a left side, and a right side, wherein the top surface has a chamber, the chamber having a back, a middle and a front, the front of the chamber being defined by a stop that is transparent to an operating wavelength of light, and wherein the back end of the body has an opening therein that is defined by a guide surface, a crossbeam, the left side of the body, and the right side of the body, wherein the opening extends from the back end of the body into the chamber and is adapted to allow end portions of a plurality of optical fibers to be inserted through the opening and received in the chamber, the chamber having a bottom surface having a first surface portion and a second surface portion, the first surface portion extending from the back of the chamber to approximately the middle of the chamber, the second surface portion extending from the first surface portion to the front of the chamber, the second surface portion having a plurality of grooves formed therein for holding respective end portions of a plurality of optical fibers;
a plurality of optical coupling elements formed in the stop, each of the optical coupling elements being aligned with a respective one of the grooves such that when the end portions of the optical fibers are held in the grooves, ends of the respective optical fibers are in alignment with the respective optical coupling elements; and
a cover adapted to be secured to the body such that at least a bottom portion of the cover is disposed inside of the chamber in abutment with the end portions of the optical fibers when the optical fibers are held in the respective grooves.

2. The optics system of claim 1, further comprising:
a refractive index matching epoxy disposed in the chamber and in contact with the ends of the optical fibers.

3. The optics system of claim 1, wherein at the back of the chamber, the first surface portion is a small distance in an X-direction of an X, Y, Z Cartesian Coordinate System below the guide surface.

4. The optics system of claim 3, wherein the top surface of the optics system is substantially parallel to the bottom surface of the optics system, and wherein the guide surface is substantially parallel to the top and bottom surfaces of the optics system and to a Y-Z plane of the X, Y, Z Cartesian Coordinate System.

5. The optics system of claim 4, wherein as the first surface portion transitions from the back of the chamber to the middle of the chamber, the first surface portion slopes upwardly such that the upwardly-sloped portion has a positive slope relative to an X-Y plane of the X, Y, Z Cartesian Coordinate System.

6. The optics system of claim 3, wherein the top surface of the optics system is at a non-zero angle of inclination, α, relative to the bottom surface of the optics system, and wherein the guide surface is substantially parallel to the top surface of the optics system.

7. The optics system of claim 6, wherein the first surface portion of the bottom surface of the chamber is a non-planar surface.

8. The optics system of claim 7, wherein the first surface portion includes a downwardly-sloped portion and an upwardly-sloped portion, the downwardly-sloped portion extending from the back of the chamber toward the middle of the chamber and ending before reaching the middle of the chamber, the upwardly-sloped portion beginning where the downwardly-sloped portion ends and extending to the approximately the middle of the chamber, wherein the downwardly-sloped portion has a negative slope relative to an X-Y plane of the X, Y, Z Cartesian Coordinate System, and wherein the upwardly-sloped portion has a positive slope relative to the X-Y plane of the X, Y, Z Cartesian Coordinate System.

9. The optics system of claim 6, wherein the angle of inclination, α, is in a range of from about 5° to about 30°.

10. The optics system of claim 9, wherein the angle of inclination, α, is in a range of from about 9° to about 15°.

11. The optics system of claim 9, wherein the optical coupling elements are total-internal-reflection (TIR) lenses that are designed to fold respective optical pathways between the respective ends of the optical fibers and the respective optoelectronic elements of the optical communications module by a bend angle, β, that is equal to α plus 90°.

12. The optics system of claim 1, wherein the optical coupling elements are total-internal-reflection (TIR) lenses that are designed to fold respective optical pathways between the respective ends of the optical fibers and the respective optoelectronic elements of the optical communications module by a bend angle, β, that is equal to approximately 90°.

13. The optics system of claim 1, wherein the body is a unitary part comprising molded plastic.

14. The optics system of claim 2, wherein the fiber ends are only separated from the stop by portions of the refractive index matching epoxy that is disposed on the ends of the optical fibers.

15. The optics system of claim 1, wherein the chamber has a length from the back of the chamber to the front of the chamber of approximately 1.6 millimeters (mm).

16. The optics system of claim 15, wherein the grooves are V-shaped grooves, and wherein each groove has a length of approximately 0.8 mm.

17. A method for coupling light between ends of optical fibers secured to an optics system and respective optoelectronic elements of the optical communications module, the method comprising:
mounting an optics system on an optical communications module, the optics system comprising:
a body having a chamber formed in a top surface thereof, the chamber having a back, a middle and a front, the front of the chamber being defined by a stop that is transparent to an operating wavelength of light, and wherein the back end of the body has an opening therein that is defined by a guide surface, a crossbeam, a left side of the body, and a right side of the body, wherein the opening extends from the back end of the body into the chamber, and wherein end portions of a plurality of optical fibers extend through the opening into the chamber, the chamber having a bottom surface having a first surface portion and a second surface portion, the first surface portion extending from the back of the chamber to approximately the middle of the chamber, the second surface portion extending from the first surface portion to the front of the chamber, the second surface portion having a plurality of grooves formed therein in which the respective end portions of the optical fibers are held,
a plurality of optical coupling elements formed in the stop, each of the optical coupling elements being aligned with a respective one of the grooves such that the ends of the respective optical fibers held in the grooves are in alignment with the respective optical coupling elements, and
a cover secured to the body such that at least a bottom portion of the cover is disposed inside of the chamber in abutment with the end portions of the optical fibers held in the respective grooves; and
using the optical coupling elements to couple light between the ends of the optical fibers and the respective optoelectronic elements of the optical communications module.

18. The method of claim 17, wherein a refractive index matching epoxy is disposed in the chamber in contact with the ends of the optical fibers.

19. The method of claim 16, wherein at the back of the chamber, the first surface portion of the bottom surface of the chamber is a small distance in an X-direction of an X, Y, Z Cartesian Coordinate System below the guide surface.

20. The method of claim 19, wherein the top surface of the optics system is substantially parallel to a bottom surface of the optics system, and wherein the guide surface is substantially parallel to the top and bottom surfaces of the optics system and to a Y-Z plane of the X, Y, Z Cartesian Coordinate System.

21. The method of claim 20, wherein as the first surface portion transitions from the back of the chamber to the middle of the chamber, the first surface portion slopes upwardly such that the upwardly-sloped portion has a positive slope relative to an X-Y plane of the X, Y, Z Cartesian Coordinate System.

22. The method of claim 19, wherein the top surface of the optics system is at a non-zero angle of inclination, α, relative to a bottom surface of the optics system, and wherein the guide surface is substantially parallel to the top surface of the optics system.

23. The method of claim 22, wherein the first surface portion of the bottom surface of the chamber is a non-planar surface.

24. The method of claim 20, wherein the first surface portion includes a downwardly- sloped portion and an upwardly-sloped portion, the downwardly-sloped portion extending from the back of the chamber toward the middle of the chamber and ending before reaching the middle of the chamber, the upwardly-sloped portion beginning where the downwardly-sloped portion ends and extending to approximately the middle of the chamber, wherein the downwardly-sloped portion has a negative slope relative to an X-Y plane of the X, Y, Z Cartesian Coordinate System, and wherein the upwardly-sloped portion has a positive slope relative to the X-Y plane of the X, Y, Z Cartesian Coordinate System.

25. The method of claim 22, wherein the angle of inclination, α, is in a range of from about 5° to about 30°.

26. The method of claim 25, wherein the angle of inclination, α, is in a range of from about 9° to about 15°.

27. The method of claim 25, wherein the optical coupling elements are total-internal-reflection (TIR) lenses that are designed to fold respective optical pathways between the respective ends of the optical fibers and the respective optoelectronic elements of the optical communications module by a bend angle, β, that is equal to α plus 90°.

28. The method of claim 17, wherein the optical coupling elements are total-internal-reflection (TIR) lenses that are designed to fold respective optical pathways between the respective ends of the optical fibers and the respective optoelectronic elements of the optical communications module by a bend angle, β, that is equal to approximately 90°.

30. The method of claim 17, wherein the body is a unitary part comprising molded plastic.

31. The method of claim 19, wherein the fiber ends are only separated from the stop by portions of the refractive index matching epoxy that are disposed on the ends of the optical fibers.

32. The method of claim 17, wherein the chamber has a length from the back of the chamber to the front of the chamber of approximately 1.6 millimeters (mm).

33. The method of claim 32, wherein the grooves are V-shaped grooves, and wherein each groove has a length of approximately 0.8 mm.
